(19) United States
(12) Patent Application Publication
(10) Pub. No.: US 2002/0089525 A1
(43) Pub. Date: Jul. 11, 2002

(54) Method for automatically adjusting display quality

(76) Inventor: Liang-Chi Huang, Yunlin (TW)

Correspondence Address: RABIN & CHAMPAGNE, P.C., Suite 500, 1101 14th Street, N.W., Washington, DC, 20005, US

(21) Appl. No.: 10/032,008

(22) Filed: Dec. 31, 2001

(30) Foreign Application Priority Data
Jan. 5, 2001 (TW) 090100318

(51) Int. Cl. G09G 5/02

(52) U.S. Cl. 345/698

(57) ABSTRACT

A method for automatically adjusting display quality is disclosed. The method includes the following steps. First, a set of frame data with a set of display timings is provided, wherein the set of display timings has a display resolution. Second, the set of frame data is auto-phased so as to obtain a set of phase data. Then, the display resolution is compared with the pre-stored standard resolutions. When the display resolution corresponds to one of the pre-stored standard resolutions, H-positioning is automatically performed to get a set of H-pos (Horizontal position) data and the set of H-pos data is stored finally.

This application incorporates by reference of Taiwan application Serial No. 90100318, filed Jan. 5, 2001.

### BACKGROUND OF THE INVENTION

1. Field of the Invention

The invention relates in general to a method for adjusting display quality, and more particularly to a method for adjusting the display quality of the display automatically and quickly.

2. Description of the Related Art

With the improvement and innovation of science and technology, the development of display technology changes daily and makes progress at a tremendous pace. The traditional CRT (Cathode Ray Tube) display has gradually dropped out the high-grade display market due to its large volumes and serious radiation and is gradually replaced by LCD (Liquid Crystal Display), which has low radiation, low power consumption, thin and small volumes. Because of the above advantages, LCD has become the main stream of the high-grade display market and even the byword of the high-grade display. Nowadays notebook computers and projectors all adopt LCDs and even more and more desktop computer users also choose the LCD monitor instead of the traditional CRT monitor.

The display screen is composed of a number of picture elements, called pixels. The pixel is the basic unit of the screen. The pixels determine the color and brightness of the frame to be displayed according to the pixel data input to the display, which correspond to the proportions of three primary colors, namely, red, blue, and green of the pixel. The whole screen is composed of each pixel of different colors and brightness. A high resolution indicates more pixels. In general, the resolution of a display screen is represented by the number of pixels of each row in the horizontal direction multiplied by the number of pixels of each column in the vertical direction. For example, a display of resolution 1024×768 represents that the display has 1024 pixels in each row in the horizontal direction and 768 pixels in each column in the vertical direction, that is, in total 1024×768 pixels in the whole screen.

The frame data input to the display can divide into two parts—pixel data and display timings. The pixel data are the proportions of three fundamental colors red, blue, green that each pixel of the screen displays, which determine the color and brightness of each pixel. In addition to the pixel data, the frame data include a set of display timings, which has three parameters, individually Hs (Horizontal Synchronal signal), Vs (Vertical Synchronal signal), and CK (pixel clock). The unit of these three parameters is frequency. CK (pixel clock) represents the number of the pixels per second, which determines the interval between the action of displaying colors of some pixel and that of the next pixel. When the pixel corresponding to the input pixel data is the pixel of the last column in the row, Hs (Horizontal Synchronous signal) controls to display the pixel of the first column in the next row. Therefore, Hs (Horizontal Synchronous signal) determines the number of the rows per second. When the pixel corresponding to the input pixel data is the pixel of the last column of the last row in the screen, Vs (Vertical Synchronous signal) controls to display the first pixel of the first row. Therefore, Vs (Vertical Synchronous signal) determines the number of the displayed frames per second.

When the frame data are input to the display, from the pixel of the first column of the first row, the display starts to display colors according to the pixel data of the input frame data that corresponds to the pixel. Then, the same operation is sequentially performed to the pixel of the second column of the first row, the pixel of the third column of the first row, and so on until the pixel of the last column of the first row. Then, the same operation is sequentially performed to the pixel of the first column of the second row, the pixel of the second column of the second row, and so on until the pixel of the last column of the second row. Then, with analogy, the same operation is sequentially performed until the pixel of the last column of the last row. By doing so, the frame to be displayed is formed by piecing together the colors that each pixel displays. When another frame data are input to the display, from the pixel of the first column of the first row again, the display follows the same sequence to determine the colors that each pixel should display, and then another frame is pieced together.

Due to the temporary visual stay phenomenon of human eyes, if the update speed of the displayed frames is fast up to some degree for human eyes, the quickly updating frames are combinations of consecutive frames, that is, films, instead of one-by-one swiftly flickering frames. The update speed of different frames in the display screen is called the refresh rate, that is, the frequency of Vs (Vertical Synchronous signal). At present, the refresh rate for general computer systems is above 60 Hz. That is to say, the display screen is capable of displaying at least 60 frames per second.

FIG. 1A is a diagram showing the frame data of low resolution displayed in the screen. The frames displayed in LCD are usually full frames in the full screen. However, the resolution of the frame data input to the display is not always identical to the resolution of the display screen. Therefore, the display can receive frame data of different resolutions, and then display the full frames in the full screen by means of the operation of the MCU (Micro Control Unit) embedded in the display. For example, if the resolution of the frame data 100 is 800×600, and the resolution of the display screen is 1024×768. Since the number of pixels of the frame data 100 is less than that of the display screen, the frame cannot completely fill the screen if the frame data 100 is directly displayed. Therefore, in order to display the frame data in the full screen, the number of pixels of the frame data 100 should be expand to 1024×768 by some means of algorithms. There are many algorithms to achieve this goal, and interpolation is one of the commonly used methods. In the interpolation, Pn, the first pixel of the first column of the first row of the frame data 100 is displayed at Pm, the location of the first column of the first row of the display screen. Afterwards, the pixels of the frame data and pixels obtained by the interpolation are sequentially displayed, which forms the 1024×768 frame 102 and fills up the screen, as shown in FIG. 1B.

While using a LCD monitor, a user may meet some problems that result in poor quality of the output frame, including flickering, unclear resolution, frame not being displayed in the center of the screen, and so on. Adjustment can be performed to improve the quality of the frame. In general, the quality of the output frame of the display can be improved through adjusting the following four parameters, that is, respectively H-pos (Horizontal position) adjustment, V-pos (Vertical position) adjustment, the phase adjustment, and the pixel clock adjustment. The four adjustment methods can make the frame quality stable. When a graphics card leaves a factory, its pixel clock and V-pos are generally quite accurate. Therefore, the pixel clock adjustment and V-pos adjustment have limited effect on the improvement of the frame quality. On the other hand, H-pos and the phase have close relationship with the frame quality and thus need to be precisely adjusted. In the following paragraph, the conventional method for auto-adjustment will be further illustrated.

When users feel that the frame quality of the display is not good, they can press the auto-adjustment button of the monitor to perform auto-adjustment of the frame quality. During this adjustment, the auto-adjustment device of the display fetches signals of the input frame data and then respectively performs H-pos (Horizontal position) adjustment, V-pos (Vertical position) adjustment, the phase adjustment, and the pixel clock adjustment to improve the frame quality. For some displays, the auto-adjustment device is controlled by software. Therefore, when the frame data are fed into the display, the auto-adjustment device can perform auto-adjustment according to signals of the frame data to improve the frame quality of the display.

When the conventional method is used for adjusting the frame quality, the following problem may happens. For most users not familiar with the operation of LCD, they are not aware that the frame quality can be adjusted only through pressing the auto-adjustment button. Thus, users may misunderstand that the products have defects and then turn to the customer service staff of the company that manufactures or sells the display. This problem can be solved through the explanation of the customer service staff. However, it takes some time for both the users and the staff to resolve the issue.

In addition, when the display uses the conventional method to perform the auto-adjustment, four adjustments, including H-pos (Horizontal position) adjustment, V-pos (Vertical position) adjustment, the phase adjustment and the pixel clock adjustment, should be completely performed, which makes the time for auto-adjustment very long. It takes approximately seven seconds to perform an auto-adjustment. In practical operation of auto-adjustment, it generally does not need to adjust all the parameters. Instead, the displayed frame can easily achieve the required quality only by means of adjusting parts of the parameters. For the display timings of the frame data fed to the display from the graphics card, the pixel clock is generally the parameter that has the least necessity. However, while the auto-adjustment is performed according to the conventional method, adjusting the pixel clock takes the longest duration of time, approximately three seconds. The parameter that is most needed for adjustment is the phase, and the duration for the phase adjustment is very short. During the operation of auto-adjustment, if the display timings of the input frame data have been changed, then due to the time limitation, the operation of auto-adjustment is not completed and the phase adjustment is not performed yet. That results in incorrect phase and flickering, not achieving the effect of adjusting the frame quality.

Moreover, the conventional auto-adjustment is bound to perform V-pos (Vertical position) adjustment in the frame data. The so-called V-pos (Vertical position) adjustment is the step described above, which displays the pixel of the first column of the first row at the top left corner of the monitor. If the resolution of the frame data is the resolution capable of full screen display, then undoubtedly, V-pos (Vertical position) adjustment can achieve the goal of full screen display. Conversely, if the resolution of the frame data 104 is not the specific resolution for full screen display, for example 950×700, then the frame drifts and does not show at the center of the monitor, as shown in FIG. 1C. Therefore, the drifting frame is inconsistent with the full-screen frame that users are accustomed to, and is an inconvenience to the users.

In addition, the auto-adjustment device of some displays is controlled by software and performs the auto-adjustment according to the display timings of the input frame data. After auto-adjustment, the parameters of the frame qualities are then stored. However, the conventional auto-adjustment device can only store a set of parameters of the frame qualities. The parameters of the display timings for each graphics card are not generally identical. Thus, the quality of the frame shown on the display may be degraded when a new signal source which is different from the signal source previously fed into the display is applied to the display, for example, when new computer system or new graphics card is used.

In brief, the conventional method for automatically adjusting the frame has the following disadvantages.

1. Problems due to users' unfamiliarity to the operation of the display monitor results in waste of time for the users and the customer service staff.

2. The time for auto-adjustment is long and is not effectively used. The time is wasted on the pixel clock that is not necessarily to be adjusted. However, phase adjustment, the most required process, is not performed and frame flickering may thus occur. The effect of auto-adjustment for the frame quality cannot be achieved effectively.

3. If the set of display timings that the user uses is not the standard one stored in the memory, the frame deviates to the upper left corner, causing the inconvenience to the user.

4. When the user changes new signal sources and the set of display timings is not identical to the original one, then the frame quality becomes worse.

### SUMMARY OF THE INVENTION

It is therefore an object of the invention to provide a method for automatically adjusting the display quality, which achieves the following objectives:

1. The frame quality can be automatically adjusted without the manual adjustment.

2. The time for auto-adjustment can be saved.

3. If the set of display timings is the standard one pre-stored in the memory, the frame is displayed in the center of the screen.

4. The auto-adjustment can be performed many times to achieve the better frame quality.

The invention achieves the above-identified objectives by providing a method for automatically adjusting the display quality, which is used for doing image adjustment of the display that has an auto-adjustment device. The method for automatically adjusting the display quality includes the following steps. First, a set of frame data with a set of display timings is provided and the set of display timings has a display resolution. Second, auto-phasing of the set of frame data is performed so as to obtain a set of phase data. Then, the display resolution is compared with the pre-stored standard resolutions. When the display resolution corresponds to one of the pre-stored standard resolutions, H-positioning is automatically performed so as to get a set of H-pos (Horizontal position) data and the set of H-pos data is stored finally.

Other objects, features, and advantages of the invention will become apparent from the following detailed description of the preferred but non-limiting embodiments. The following detailed description is made with reference to accompanying drawings.

### BRIEF DESCRIPTION OF THE DRAWINGS

FIG. 1A is a diagram showing the frame data of low resolution, which are displayed on the screen.

FIG. 1B is a diagram that shows the frame data of low resolution shown in FIG. 1A filling the screen.

FIG. 1C is a diagram showing the frame data deviating from the center of the screen.

FIG. 2 is a block diagram showing a kind of auto-adjustment devices of the display.

FIG. 3A is a diagram showing a method for latching analog signals.

FIG. 3B is a diagram showing another method for latching analog signals.

FIG. 3C is a diagram showing the phase data obtained from two kinds of latch signals.

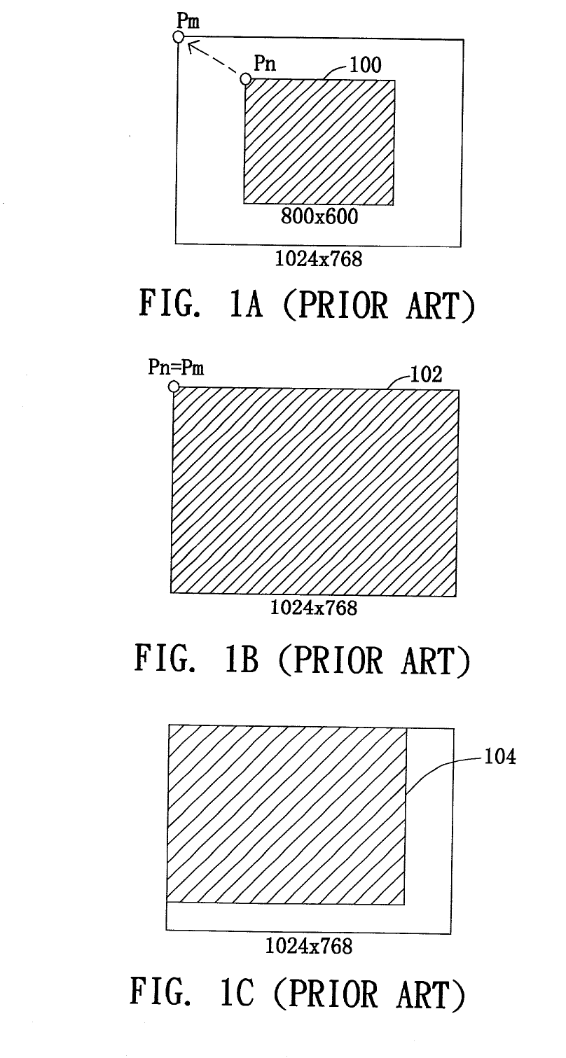

### DESCRIPTION OF THE PREFERRED EMBODIMENT

Conventionally, four parameters affect the frame quality, that is, H-pos (Horizontal position), V-pos (Vertical position), the phase, and the pixel clock. In general, the pixel clock and V-pos (Vertical position) are pretty accurate and unlikely to have great effect on the frame quality even if the adjustments are not performed. It is H-pos and the phase that have greater effect on the frame quality. Adjusting H-pos can make the frame displayed in the center of the screen of the monitor. Adjusting the phase can make the frame clearer and not flickering. Therefore, the method for automatically adjusting the frame quality, which is proposed in the present invention, only focuses on the phase and H-pos to perform the adjustment. By doing so, the time for auto-adjustment can be substantially saved. Therefore, the auto-adjustment can be performed quickly once the frame data are input, which avoids the operation of auto-adjustment losing efficacy when the display timings of the input frame data change quickly.

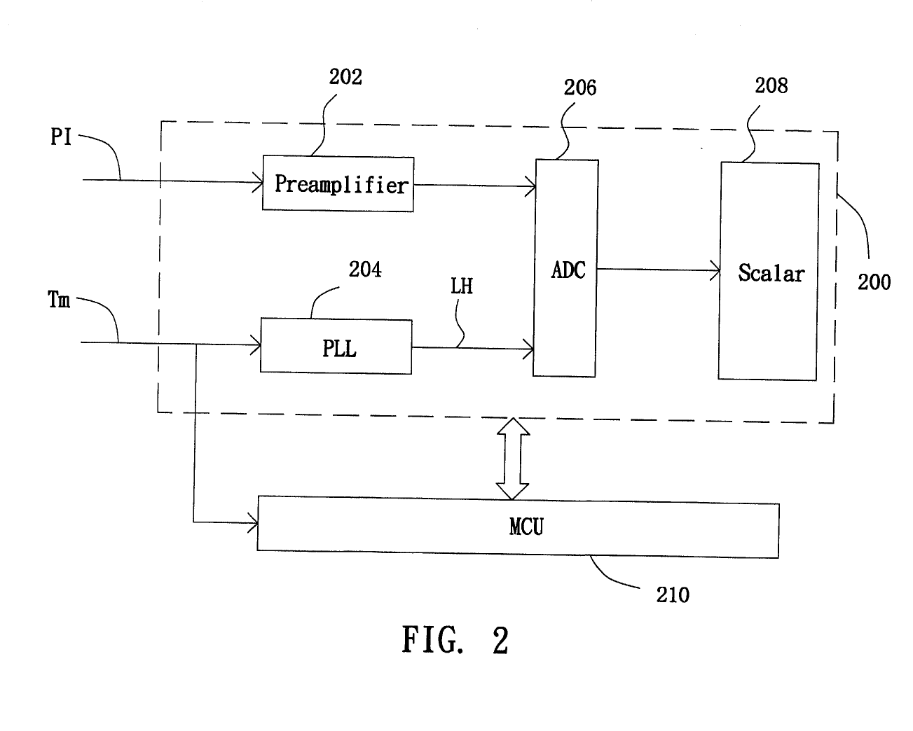

FIG. 2 is a block diagram showing the auto-adjustment device of the display. The auto-adjustment device 200 includes a preamplifier 202, a PLL (Phase Lock Loop) 204, an ADC (Analog-to-Digital Converter) 206, a scalar 208, and a MCU (Micro Control Unit) 210. The relationship between each component is shown in the block diagram and thus not described in details. In the following paragraph, the auto-adjustment device 200 is taken as an example to illustrate the method for automatically adjusting the image quality, which is proposed in the present invention.

First, frame data are fed into the auto-adjustment device 200. As everybody knows, the frame data are composed of three fundamental colors, that is, red (R), green (G), and blue (B). The pixel data Pl of the frame data are analog signals of the proportions of three fundamental colors RGB. In general, the normal voltage of input signal is 0.7 Volt (peak to peak value). If the input signal is not 0.7 Volt, then by means of the preamplifier 202, the frame data are adjusted to be 0.7 Volt and then fed into the ADC 206 for analog-to-digital conversion.

The frame data fed into the auto-adjustment device 200 include pixel data Pl and display timings Tm. The display timings have three parameters, horizontal synchronal signal (Hs), vertical synchronal signal (Vs), and pixel clock (CK). These three parameters determine the resolution of the frame data. The display timings Tm are fed into a PLL 204 of the auto-adjustment device 200. The PLL 204 locks the frequency of Hs after receiving Hs, and then generates a latch signal LH of the same frequency as the input CK (pixel clock). Then, the latch signal LH is fed into the ADC 206 for analog-to-digital conversion. In the operation of analog-to-digital conversion, the ADC 206 can fetch the pixel data Pl that are adjusted by the preamplifier 202 according to the latch signal LH. By doing so, analog signals are converted to digital signals, which are then fed into the scalar 208 to perform the adjustment of the frame data.

Take the display timings of XGA specifications for example. The resolution of the frame data is 1024×768. The frequency of Hs (Horizontal Synchronal signal) is 48.36 KHz, the frequency of Vs (Vertical Synchronal signal) is 65 KHz, and the frequency of the pixel clock is 65 MHz. After receiving Hs (Horizontal Synchronal signal) of 48.36 KHz, the PLL 204 bases on it to generate the latch signal LH. Because the frequency of the latch signal LH is same as CK (pixel clock), the ADC 206 can precisely read out the data of each pixel while using the latch signal LH to fetch the pixel data Pl.

In the adjustment of the frame data, the MCU 210 receives the display timings of the frame data and then adjust the PLL 204 based on the result obtained from the operation of the scalar 208 done to the frame data, making the phase of the latch signal LH drift. By doing so, the sampling position of each pixel is changed and then the stability of the sampling result can be adjusted. Therefore, it is known that the display can achieve the best display effect by means of the operation of this feedback system. This step is the auto-phase adjustment and the operation is then explained in details in the following paragraph.

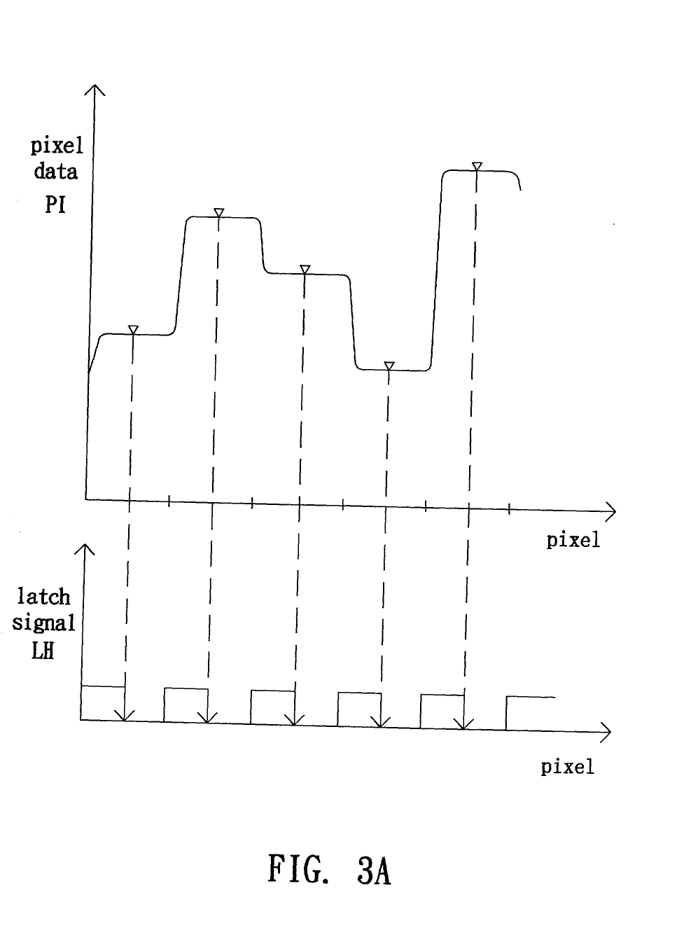

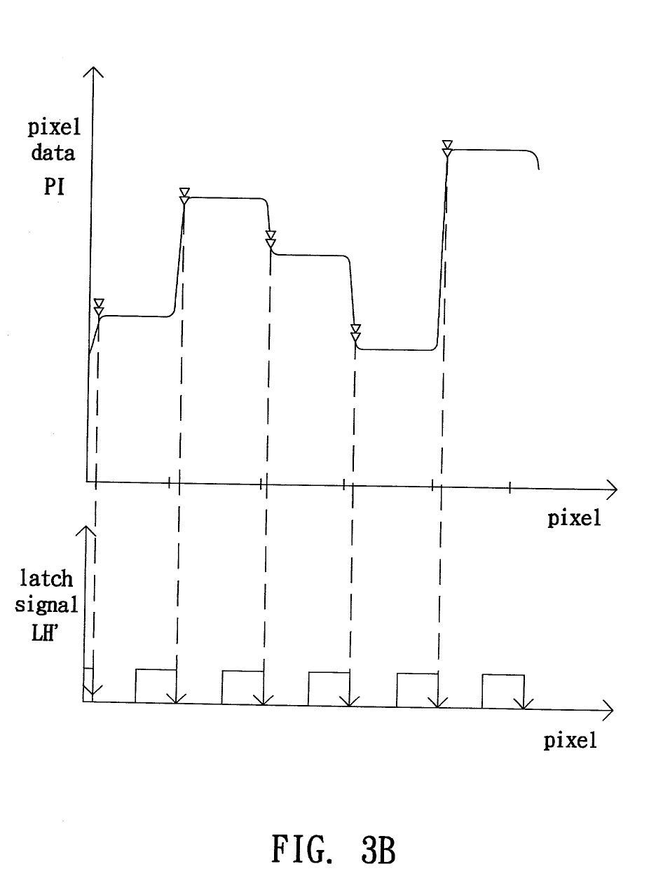

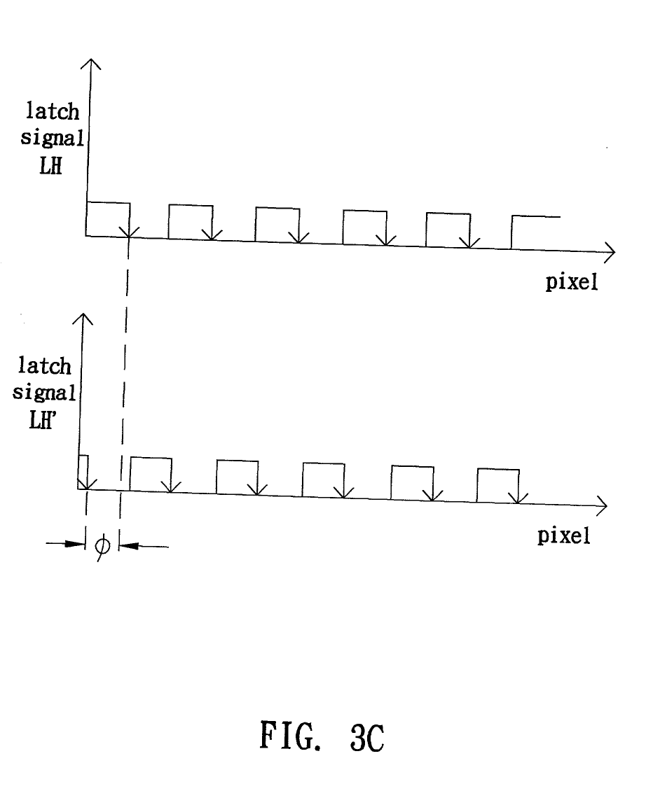

FIG. 3A is a block diagram showing the method for latching analog signals. As described above, the ADC 206 receives the pixel data Pl input from the preamplifier 202. Because the pixel data Pl are analog signals, thus in the operation of analog-to-digital conversion, the latch signal LH must be used to successively fetch value of each pixel. This step is called sampling. In practical application, the signal synchronizing with the pixel data Pl is adopted as the latch signal LH, that is used to sample the pixel data Pl. Take FIG. 3A for example, the method of negative-edged trigger is used to fetch the value of the pixel data Pl and then obtain the discrete signals of data. Then, the discrete signals of data are converted to digital forms, completing the operation of converting analog signals to digital signals. Note that the PLL 204 can determine not only the sampling frequency of analog signals but also the sampling position of the successive pixel data signals in fixed periods. If the position of each sampling operation is shown as FIG. 3A, because the signals of the pixel data at the sampling position are stable, the frame composed of the sampling results is clearer, more stable, and less flickering.

Conversely, if the sampling position of the latch signal is not good, the stability of the sampling results is heavily affected, resulting in the degraded frame quality. FIG. 3B is another block diagram showing the method for latching analog signals. As shown in FIG. 3B, the negative edge of the latch signal LH′ is exactly located at the transitional state of the pixel data Pl. Consequently, the pixel data Pl latched by the latch signal LH′ is not stable enough, which results in flickering. By comparison, it is found that the phase of the latch signal LH is different from that of the latch signal LH′. That is, the difference between LH and LH′ is the phase φ, as shown in FIG. 3C. Therefore, while adjusting the PLL 204, the MCU 210 aims at the phase φ of the latch signal to do adjustments, which makes the pixel data fetched by the latch signal is the value at the stable state, thereby obtaining the best display. Once the phase adjustment is completed, the final phase data can be recorded. Then, the phase data adjusted last time can be used in the next start-up and make the frame maintain the optimal state.

Note that when a new set of display timings is input, the auto-adjustment device automatically adjusts the frame quality by performing the frame quality adjusting operation. If users connect the display with different signal sources, such as different mainframes or graphics cards, the display timings input to the display are changed and the auto-adjustment is needed for the better display quality. The feature of the present invention lies in the function that the auto-adjustment is capable of being repeated so that the automatic frame quality adjusting operation can be performed in response to the changes of the display timings of the input frame data. Besides, the phase data obtained from the auto-adjustment are stored in the EEPROM (Electrically Erasable Programmable Read-Only Memory).

The resolution of a display is fixed. If the frame data have a resolution greater than the resolution of the display, the frame data will be unable to be displayed. If the frame data have a resolution identical to the resolution of the display, the frame data will be displayed in full-screen manner. As to the frame data with a resolution smaller than the resolution of the display, they can be displayed in a non full-screen manner. However, users are accustomed to the frame data to be displayed in the center of the screen. Therefore, in order to maintain the frame quality, after the automatic phase adjustment is performed, the resolution of the frame data is detected so as to determine whether the frame data can be displayed on the screen and to determine where the frame data are to be displayed on the screen of the display. This detection is called the automatic horizontal position adjustment. Display manufacturers generally pre-store several sets of commonly used display timings in the memory of the MCU 210. A variety of memories fit in with the needed feature of the present invention, such as EEPROM (Electrically Erasable Programmable Read-Only Memory), Flash ROM (Flash Read-Only Memory), and so on. While determining whether H-pos (Horizontal position) adjustment is needed to be performed, the MCU 210 reads the set of display timings of the frame data obtained from the operation of the scalar 208, and then compares it with the standard one pre-stored in the EEPROM of the MCU 201. If the set of display timings of the frame data is not consistent with one set of standard display timings pre-stored in the memory, then exit the auto-adjustment device and do not perform the automatic H-pos (Horizontal position) adjustment. Conversely, if the set of display timings is consistent with one set of standard display timings pre-stored in the memory, the MCU 210 can calculate H-pos (Horizontal position) of the input frame data, based on the value read by the scalar 208. Then, the MCU 210 performs H-pos (Horizontal position) adjustment, which makes the pixel data of the first column out of the whole frame data displayed in the pixel of the first column of the monitor screen, thereby getting the optimal display effect. For example, suppose that the resolution of the input frame data is 800×600 and the resolution of the monitor screen is 1024×768. The MCU 210 can use the value read by the scalar 208 to determine the resolution of the input frame data, and then compares the determined resolution with the standard horizontal resolution pre-stored in the memory. Then, it is found that the horizontal resolution of 800×600 is one of the standards pre-stored in the memory. The MCU 201 can use the determined result to obtain a set of H-pos data, and then uses the H-pos data to adjust the scalar 208. By doing so, the pixel data of the first column out of the whole frame data is displayed in the pixel of the first column of the monitor screen. The foregoing operations altogether are called the automatic H-pos (Horizontal position) adjustment.

Therefore, the foregoing preferred embodiment of the present invention discloses a method for automatically adjusting the frame quality of the display, which includes the following advantages.

1. The frame quality can be adjusted automatically without the manual adjustments, which reduces the disturbance and waste of time for users and the staff who manufacture or sell the display.

2. The time for auto-adjustment can be saved, which avoids the operation of auto-adjustment losing efficacy because of the quick changes of the display timings of the frame data.

3. The frame quality can be adjusted many times, which avoids the problem of poor frame quality while users changes different signal sources.

4. If the set of display timings is the standard horizontal resolution pre-stored in the memory, then the frame is displayed in the center of the screen.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for automatically adjusting display quality, which is used for adjusting a display, the method comprising the steps of:
providing a set of frame data with a set of display timings, wherein the set of display timings has a display resolution;
auto-phasing the set of frame data to obtain a set of phase data; and
comparing the display resolution with a set of standard resolutions, and automatically H-positioning to obtain a set of H-pos (Horizontal position) data and storing the set of H-pos when the display resolution corresponds to one of the set of standard resolutions.

2. The method for automatically adjusting display quality according to claim 1, wherein the display is a LCD (Liquid Crystal Display).

3. The method for automatically adjusting display quality according to claim 1, wherein the display is a projector.

4. The method for automatically adjusting display quality according to claim 1, wherein the method can be performed repeatedly to perform multiple adjustments.

5. The method for automatically adjusting display quality according to claim 1, wherein the resolution is 1024×768.

6. The method for automatically adjusting display quality according to claim 1, wherein the set of standard resolutions are stored in a memory of the display.

7. The method for automatically adjusting display quality according to claim 1, wherein the memory is a Flash ROM (Flash Read-Only Memory).

8. The method for automatically adjusting display quality according to claim 1, wherein the memory is an EEPROM (Electrically Erasable Programmable Read-Only Memory).
